(19) United States
(12) Patent Application Publication
(10) Pub. No.: US 2026/0071729 A1
(43) Pub. Date: Mar. 12, 2026

(54) SOLAR POWERED LIGHTING DEVICE AND METHOD OF USING THE SAME

(71) Applicant: BAICHUANG (GUANGZHOU) ELECTRIC CO., LTD, GUANGZHOU (CN)

(72) Inventor: YING SHI, GUANGZHOU (CN)

(21) Appl. No.: 19/196,751

(22) Filed: May 2, 2025

(30) Foreign Application Priority Data
Sep. 10, 2024 (CN) 202422206510.6

(51) Int. Cl. F21S 9/03; F21S 8/06; F21V 23/04; F21W 131/10; F21Y 115/10

(52) U.S. Cl. CPC F21S 9/037; F21S 8/061; F21V 23/0471; F21W 2131/10; F21Y 2115/10

(57) ABSTRACT

A solar powered lighting device and a method using the same are provided, the solar powered lighting device includes an upper housing, a lighting structure, and an outer housing. The lighting structure is disposed in the outer housing, and the upper housing is fixed to a top portion of the outer housing. The lighting structure includes a solar photovoltaic panel, a solar battery compartment, a light string, and a light string accommodation unit. The light string is fixed on the light string accommodation unit, the solar battery compartment is disposed on a top portion of the light string accommodation unit, the solar battery compartment is connected to the solar photovoltaic panel, and the solar photovoltaic panel is disposed on a top portion of the upper housing.

### TECHNICAL FIELD

The present disclosure relates to the field of lighting, and in particular to solar powered lighting systems.

### BACKGROUND

Solar powered outdoor lights are fixtures that utilize solar photovoltaic panels to convert solar energy into electricity for outdoor lighting. The solar powered outdoor lights are commonly used in outdoor settings, such as streets, parks, courtyards, gardens, and parking lots, offering advantages, such as energy-saving, environmental friendliness, and ease of installation.

To address immediate lighting needs for outdoor activities, Arthur Wu, the inventor of PCT publication No. WO2021257483A1, proposed a convertible lighting device. The convertible lighting device features a housing with a battery pack and an elongated flexible light source, including a rope light switchable between a rope mode and a lantern mode. The convertible lighting device is powered by lithium-ion batteries and enables adjustable brightness and power-boosting functions. However, such lighting device is bulky and operationally cumbersome, which is unsuitable for portable use.

Meanwhile, Jeong Seungah and Salzinger John, the inventors of the PCT publication No. WO2019156973A1 disclosed a solar powered lighting device. The solar powered light device is light in weight and portable, which includes a flexible electronic cord, a rechargeable battery, and a microprocessor to enable multiple operational modes based on user input. However, prior to retracting or extending the flexible electronic cord, a housing of the solar powered lighting device needs to be opened to manually wind the flexible electronic cord around a cylindrical structure or to activate a motorized winding mechanism. After retraction or extension, the housing is reclosed. Both the pre-operation opening and post-operation closing of the housing necessitate dedicated structural mechanisms to achieve these functions. Specifically, the solar powered lighting device employs a spring mechanism or complementary mating elements such as, e.g., pairs of magnets, threads, clips, or latches to secure and release two sections of the housing. Additionally, repeated opening/closing operations require sealing elements between the two sections of the housing section to maintain environmental resistance. While the solar powered lighting device achieves lightweight portability, its reliance on housing manipulation for retraction/extension of the flexible electronic cord introduces significant drawbacks. Each use requires cyclical opening and closing actions, resulting in operational complexity, excessive mechanical components, elevated manufacturing costs, and heightened risks of structural fatigue or seal degradation. Consequently, the solar powered lighting device suffers from poor reliability and a suboptimal cost-performance ratio in practical applications.

Thus, a critical challenge in the field is to simplify structural design, reduce costs, and enhance durability while maintaining portability of solar powered lighting devices. Addressing these issues may enable the solar powered lighting devices to become indispensable tools for outdoor living.

Additionally, portable solar powered lighting devices are often deployed in remote fieldwork settings. Integrating an alarm function into such devices to deter unauthorized personnel or wildlife from approaching users represents a key direction for future multifunctional development.

### SUMMARY

Based on the above technical problems, the present disclosure provides a solar powered lighting device.

The solar powered lighting device includes an upper housing, a lighting structure, and an outer housing. The lighting structure is disposed in the outer housing, and the upper housing is fixed to a top portion of the outer housing.

The lighting structure includes a solar photovoltaic panel, a solar battery compartment, a light string, and a light string accommodation unit. The light string is fixed on the light string accommodation unit, the solar battery compartment is disposed on a top portion of the light string accommodation unit, the solar battery compartment is connected to the solar photovoltaic panel, and the solar photovoltaic panel is disposed on a top portion of the upper housing.

The upper housing includes a mounting frame, the solar photovoltaic panel is fixed in the mounting frame.

At least one indication light, a switch, a control chip, and a microwave human body thermal sensor are disposed on an upper surface of the upper housing, a buzzer is disposed in the recess, and the control chip is respectively connected to the at least one indication light, the switch, the solar battery compartment, the microwave human body thermal sensor, and the buzzer.

A solar battery is disposed in the solar battery compartment, the solar battery is electrically connected to a first end of the light string.

At least one fixing post is disposed on an inner side of the upper housing, at least one fixing groove is defined on an inner portion of the outer housing. The at least one fixing post corresponds to the at least one fixing groove. The upper housing and the outer housing are fixed through engagement of the at least one fixing post and the at least one fixing groove

The light string accommodation unit is rotatably connected to the upper housing through a bearing, or, the light string accommodation unit is rotatably connected to the solar battery compartment through the bearing.

The light string accommodation unit includes an upper fixing plate, a fixing column, and a lower fixing plate, the upper fixing plate and the lower fixing plate are connected through the fixing column, the upper fixing plate, the fixing column, and the lower fixing plate are integrated, a cross section of the light string accommodation unit is I-beam shaped, and one side of the light string is fixed on the fixing column.

A light string hook is disposed at a second end of the light string, the light string includes a light-emitting diode (LED) light string with a plurality of LEDs connected in series.

A mounting hole is defined on a bottom portion of the outer housing, a rotating plate is mounted at the mounting hole through a peripheral groove thereof, and the light string accommodation unit is fixed on the rotating plate.

A recess is defined on a first side of the rotating plate, an accommodation groove is defined on a second side of the rotating plate.

An insertion hole penetrates through the accommodation groove, the lower fixing plate defines a threaded hole configured to operatively engage with a retraction rod.

A through hole is defined on the recess, the buzzer is disposed in the recess, a rotating shaft is disposed on an outer side of the accommodation groove, and the retraction rod is threadedly disposed at an upper portion of the rotating shaft.

A hanging rope is disposed on the outer housing.

The present disclosure further provides a method of using the solar powered lighting device, including following steps.
S1: installation and fixation: hanging the solar powered lighting device on an outdoor fixing support through a hanging rope, pulling the light string hook to draw out the light string, and fixing the light string to provide uniform lighting to surrounding areas.
S2: solar charging or lighting: turning on a switch to activate the solar battery compartment to convert solar energy into electrical energy, storing the electrical energy in the solar battery or energizing the light string by the solar battery to emit light for ambient lighting.
S3: storage and carriage: turning off the switch after use, rotating the retraction rod through the rotating shaft to disengage the retraction rod from the light string accommodation unit, detaching the retraction rod from the rotating shaft, inserting the retraction rod into the threaded hole of the lower fixing plate through the insertion hole of the accommodation groove, rotating the retraction rod, fixing the retraction rod to the lower fixing plate, rotatably connecting an upper side of the light string accommodation unit to the upper housing, providing no connection between a lower side of the light string accommodation unit and the outer housing, rotating the light string accommodation unit along with the retraction rod to retract the light string into the light string accommodation unit for folding and carriage of the solar powered lighting device.

Beneficial effects of the present disclosure are as follows.

The present disclosure significantly enhances outdoor safety and operational efficiency by integrating the microwave human body thermal sensor and the buzzer. When deployed outdoors, the microwave human body thermal sensor detects nearby human or animal movement and transmits real-time signals to the control chip, which immediately triggers the buzzer to emit a loud alarm, providing users with timely alerts.

The outer housing defines an opening on a side wall thereof, enabling smooth extension and retraction of the light string without requiring housing disassembly.

The present disclosure improves upon complex light string accommodation units in the prior art to a simple structure thereof, moreover, operation of the present disclosure is entirely manual, resulting in ease of use, low cost, high cost-effectiveness, and enhanced durability.

Improvements on structure, operation, cost-to-performance ratio, and of the light string accommodation unit of the present disclosure is as follows.

### Structural Simplification

To enhance a cost-performance ratio and durability of the solar powered light device, the present disclosure optimizes the complex light string accommodation units in the prior art through a redesigned structure. The new design adopts a more simplified configuration by eliminating unnecessary mechanical components, thereby making the light string accommodation unit more compact and durable.

### Manual Operation

The light string accommodation unit of the present disclosure is easy to operate. The users may manually retract or extend the light string with minimal effort. Such design approach not only reduces manufacturing costs but also minimizes a risk of mechanical failure, thereby improving durability of the solar powered light device.

### High Cost-Performance Ratio

By simplifying the structure and enhancing durability, the present disclosure maintains functionality while significantly reducing the manufacturing costs. In this way, the solar powered light device of the present disclosure becomes more affordable and suitable for widespread consumer adoption.

The solar powered light device of the present disclosure further provides the microwave human body thermal sensor, the control chip, and the buzzer.

As a core safety component of the present disclosure, the microwave human body thermal sensor is capable of effectively detecting the nearby human or animal movement and transmitting the real-time signals to the control chip after detecting.

Upon receiving the real-time signals from the microwave human body thermal sensor, the control chip immediately triggers the buzzer to emit the loud alarm. Such audible alert not only draws immediate attention from the users but also serves as a warning signal to alert nearby individuals or animals of location of the solar powered light device of the present disclosure, thereby providing additional safety in emergency situations.

Designed as an alarm mechanism, the buzzer takes into account potential noise interference in outdoor environments. Therefore, sound output of the buzzer is sufficiently loud to be clearly heard even in noisy conditions. Additionally, the buzzer features a long service life and low maintenance cost, ensuring reliable performance over extended periods of use.

### BRIEF DESCRIPTION OF DRAWINGS

FIG. 1 is a structural schematic diagram of the present disclosure.

FIG. 2 is a first exploded schematic diagram of the present disclosure.

FIG. 3 is a bottom schematic diagram of the present disclosure.

FIG. 4 a schematic diagram illustrating operational use of the present disclosure.

FIG. 5 is a structural schematic diagram of a light string accommodation unit of the present disclosure.

FIG. 6 is another structural schematic diagram of a light string accommodation unit of the present disclosure.

FIG. 7 is a structural schematic diagram of a retraction rod of the present disclosure.

FIG. 8 is a structural schematic diagram of a light string hook of the present disclosure.

FIG. 9 is a second exploded schematic diagram of the present disclosure.

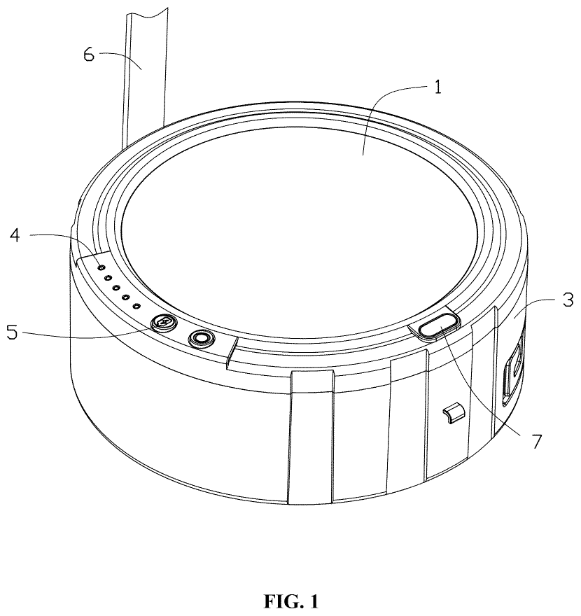

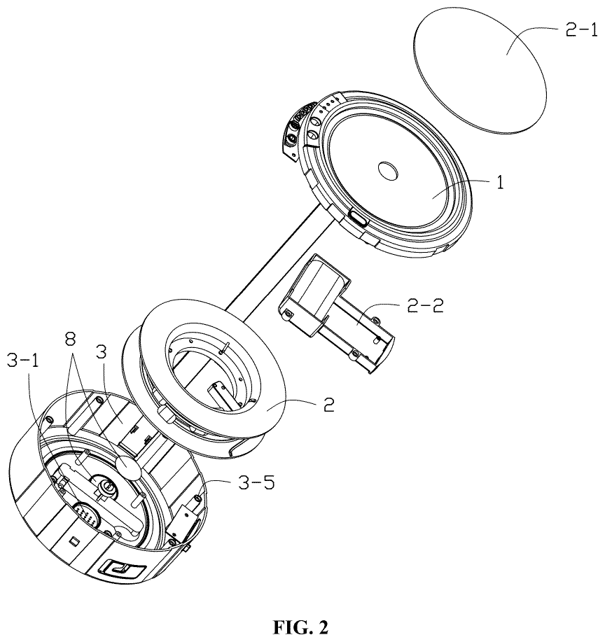

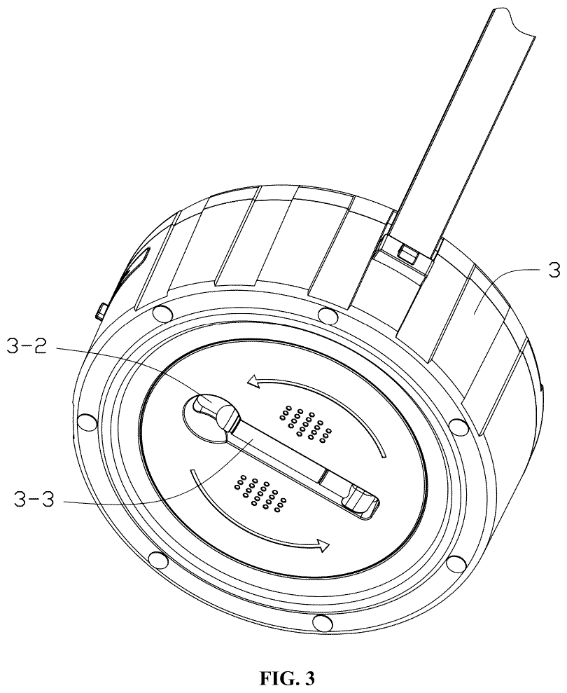

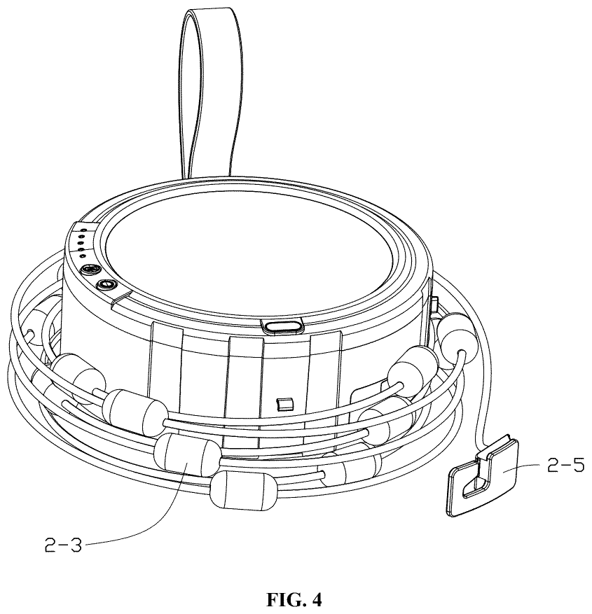

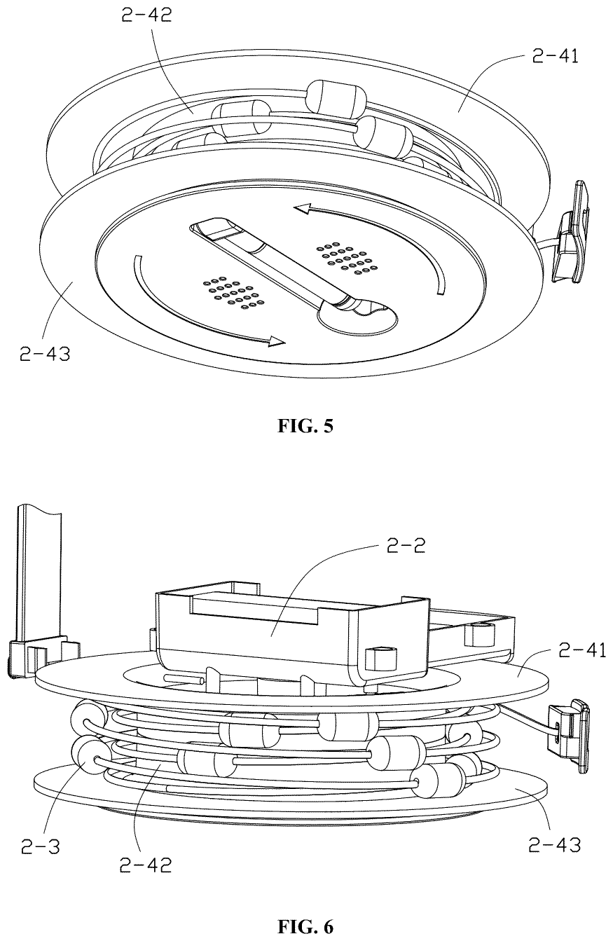

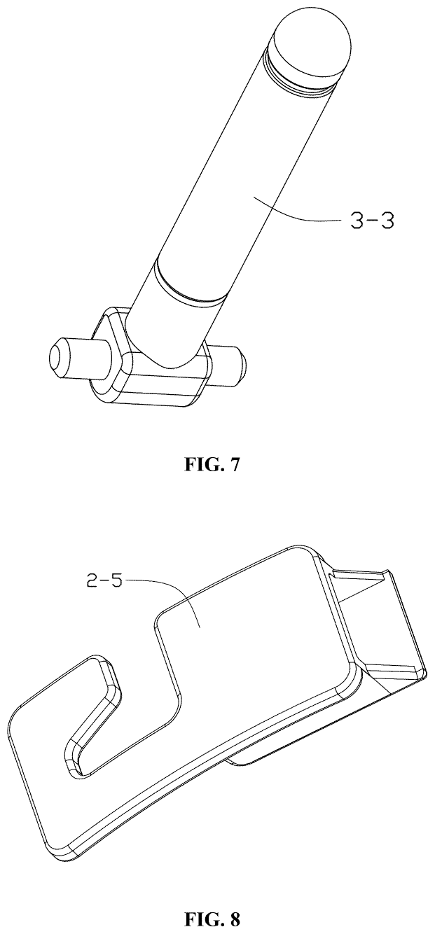

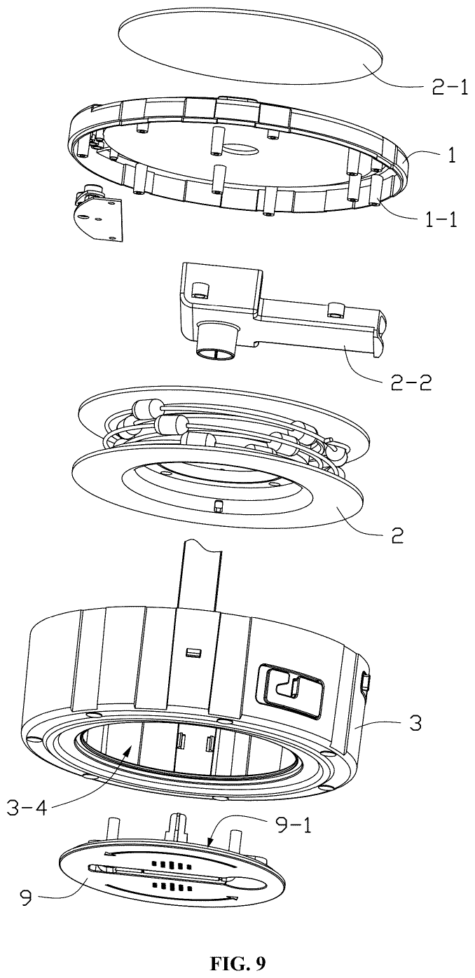

Reference numerals in the drawings: 1. upper housing; 1-1. fixing post; 2. lighting structure; 3. outer housing; 4. indication light; 5. switch; 6. hanging rope; 7. microwave human body thermal sensor; 8. buzzer; 2-1. solar photovoltaic panel; 2-2. solar battery compartment; 2-3. light string; 2-5. light string hook; 2-41. upper fixing plate; 2-42. fixing column; 2-43. lower fixing plate; 3-1. recess; 3-2. accommodation groove; 3-3. retraction rod; 3-4. mounting hole; 3-5. fixing groove; 9. rotating plate; 9-1. peripheral groove.

### DETAILED DESCRIPTION OF EMBODIMENTS

Technical solutions of the present disclosure are clearly and completely described below with reference to accompanying drawings, and obviously, the described embodiments are part of the embodiments of the present disclosure, but not all of the embodiments. All other embodiments obtained by those who skilled in the art based on the embodiments of the present disclosure without creative efforts shall fall within a protection scope of the present disclosure.

In the description of the present disclosure, it should be noted that terms “center”, “upper”, “lower”, “left”, “right”, “vertical”, “horizontal”, “inner”, “outer”, etc. refer to orientation or positional relationships as shown in the accompanying drawings. These terms are used solely for ease of description and to simplify explanation of the present disclosure, and do not indicate or imply that referred devices or components must be constructed or operated in a specific orientation. Therefore, these terms should not be construed as limiting the protection scope of the present disclosure. In addition, terms “first”, “second”, and “third” are used for descriptive purposes only and cannot be understood as indicating or implying relative importance.

In the description of the present disclosure, it should be noted that terms “disposed”, “connected with”, and “connected to” should be understood in a broad sense unless expressly specified and limited otherwise, for example, may be a fixed connection, a detachable connection, or an integral connection; a mechanical connection or an electrical connection; direct connection or connection through an intermediate medium; and may further indicate internal communication between two components. For those who skilled in the art, specific meanings of the above terms in the present disclosure may be understood according to specific situations. In addition, technical features involved in different embodiments of the present disclosure described below may be combined with each other as long as they do not conflict with each other.

### First Embodiment

The present disclosure provides a solar powered lighting device, including an upper housing 1, a lighting structure 2, and an outer housing 3. The upper housing 1, the lighting structure 2, and the outer housing 3 cooperate to form an efficient and convenient lighting system.

In the lighting structure 2, a solar photovoltaic panel 2-1 is ingeniously integrated with a solar battery compartment 2-2, providing a continuous supply of clean energy to a light string 2-3. The light string 2-3 is meticulously accommodated in a light string accommodation unit, the solar battery compartment 2-2 is disposed on a top portion of the light string accommodation unit, which ensures optimal utilization of the harvested energy. The solar photovoltaic panel 2-1 is disposed on a top portion of the upper housing 1, allowing the solar powered lighting device to absorb sunlight during the day, thereby preparing for nighttime lighting.

The upper housing 1 includes a mounting frame at the top portion thereof, and the solar photovoltaic panel 2-1 is fixed in the mounting frame, offering both aesthetic appeal and practical functionality. Additionally, at least one indication light 4, a switch 5, a control chip, and a microwave human body thermal sensor 7 are disposed on an upper surface of the upper housing 1. The control chip is respectively connected to the at least one indication light 4, the switch 5, the solar battery compartment 2-2, the microwave human body thermal sensor 7, and the buzzer 8, enabling intelligent lighting control.

The solar battery compartment 2-2 is electrically connected to the light string 2-3, ensuring smooth and uninterrupted energy transmission. At least one fixing post 1-1 is disposed on an inner side of the upper housing 1, at least one fixing groove 3-5 is defined on an inner portion of the outer housing 3, and the upper housing 1 and the outer housing 3 are fixed through engagement of the at least one fixing post 1-1 and the at least one fixing groove 3-5.

The light string accommodation unit is rotatably connected to the upper housing 1 through a bearing. The light string accommodation unit is formed by integrating an upper fixing plate 2-41, a fixing column 2-42, and a lower fixing plate 2-43, the light string accommodation unit is I-beam shaped, a first side of the light string is fixed on the fixing column, and a light string hook 2-5 is disposed at a second side of the light string 2-3 for convenient access by users.

A recess 3-1 is defined on a first side of the rotating plate 9, an accommodation groove 3-2 is defined on a second side of the rotating plate 9. A through hole is defined on the recess 3-1, the buzzer 8 is disposed in the recess 3-1 for emitting a loud alarm, a rotating shaft is disposed on an outer side of the accommodation groove 3-2, and a retraction rod 3-3 is threadedly disposed at an upper portion of the rotating shaft for storing less frequently used items. The lower fixing plate 2-43 defines a threaded hole configured to operatively engage with the retraction rod 3-3 for convenience of storage.

A hanging rope 6 is disposed on the outer housing 3, allowing the users to conveniently hang the solar powered lighting device outdoors, which not only provides warm lighting for nighttime outdoor activities but also enhances overall safety performance of the solar powered lighting device.

### Second Embodiment

The present disclosure provides the solar powered lighting device, particularly adapted for camping, exploration, and emergency rescue scenarios. By integrating intelligent lighting, safety assurance, and compact portability, the solar powered lighting device provides a comprehensive outdoor experience for the users.

Specific method of using the solar powered lighting device is as follows.

### Installation and Fixation

Hanging the solar powered lighting device on an outdoor tent through the hanging rope 6 to ensure stability in various out door environments.

Pulling the light string hook 2-5 to draw out the light string 2-3, and fixing the light string 2-3 to an appropriate position to provide uniform lighting to surrounding areas.

Ensuring that the light string hook 2-5 is securely fastened to prevent the light string 2-3 from detaching due to wind or other external forces.

### Solar Charging and Lighting

Turning on the switch 5 to activate the solar battery compartment 2-2 to convert solar energy into electrical energy, storing the electrical energy in the solar battery.

Energizing the light string 2-3 by the solar battery to emit light for ambient lighting during nighttime.

### Safety Assurance

Detecting nearby human or animal movement by the microwave human body thermal sensor 7 when unauthorized personnel or wildlife approaches.

Transmitting real-time signals to the control chip by the microwave human body thermal sensor 7, and triggering the buzzer 8 to emit the loud alarm by the control chip.

Alerting the users by the loud alarm to prevent potential dangers, thereby providing additional safety for users.

### Storage and Carriage

Turning off the switch after use to cut off power supply.

Rotating the retraction rod 3-3 through the rotating shaft to disengage the retraction rod 3-3 from the light string accommodation unit.

Detaching the retraction rod 3-3 from the rotating shaft, inserting the retraction rod 3-3 into the threaded hole of the lower fixing plate 2-43 through the insertion hole of the accommodation groove 3-2.

Rotating the retraction rod 3-3, fixing the retraction rod 3-3 to the lower fixing plate 2-43, rotatably connecting an upper side of the light string accommodation unit to the upper housing 1, providing no connection between a lower side of the light string accommodation unit and the outer housing 3, rotating the light string accommodation unit along with the retraction rod 3-3 to retract the light string 2-3 into the light string accommodation unit for folding and carriage of the solar powered lighting device.

The present disclosure not only provides convenience for nighttime lighting but also offers additional protection through the safety assurance. The combined portability and ease design of the present disclosure establish the solar powered lighting device as an essential tool for outdoor activities.

### Third Embodiment

During use of the solar powered lighting device, the solar powered lighting device is hung on the outdoor tent through the hanging rope 6. The light string 2-3 is then drawn out by the light string hook 2-5, and the light string hook 2-5 is fixed in the appropriate position to secure the lighting string 2-3. After that, the switch 5 is turned on, allowing the solar battery compartment 2-2 to supply power to the light string 2-3, then the light string 203 emits the light for lighting.

During nighttime use, if unauthorized personnel or wildlife approaches, the microwave human body thermal sensor 7 detects the nearby human or animal movement and transmits the real-time signals to the control chip, which immediately triggers the buzzer 8 to emit the loud alarm, providing the users with timely alerts and safety.

After use, the switch 5 is turned off. The retraction rod 3-3 is then rotated through the rotating shaft and subsequently detached from the rotating shaft. Next, the retraction rod 3-3 is inserted into the threaded hole of the lower fixing plate 2-43 through the insertion hole of the accommodation groove 3-2. By rotating the retraction rod 3-3, the retraction rod 3-3 is fixed to the lower fixing plate 2-43, the upper side of the light string accommodation unit is rotatably connected to the upper housing 1, a lower side of the light string accommodation unit is not connected with the outer housing 3, at this time, the light string accommodation unit rotates to retract the light string 2-3 thereinto for convenience of folding and carriage of the solar powered lighting device.

### Fourth Embodiment

During use of the solar powered lighting device, the solar powered lighting device is hung on the outdoor tent through the hanging rope 6. The light string 2-3 is then drawn out by the light string hook 2-5, and the light string hook 2-5 is fixed in the appropriate position to secure the lighting string 2-3. After that, the switch 5 is turned on, allowing the solar battery compartment 2-2 to supply power to the light string 2-3, then the light string 203 emits the light for lighting.

During nighttime use, if unauthorized personnel or wildlife approaches, the microwave human body thermal sensor 7 detects the nearby human or animal movement and transmits the real-time signals to the control chip, which immediately triggers the buzzer 8 to emit the loud alarm, providing users with timely alerts and safety.

After use, the switch 5 is turned off. The retraction rod 3-3 is then rotated through the rotating shaft to driving the rotating plate 9 to rotate on a lower housing, meanwhile, the rotating plate 9 drives the light string accommodation unit fixed thereon to rotate. The retraction rod 3-3 and the rotating plate 9 are fixed together and the upper side of the light string accommodation unit is rotatably connected to the upper housing 1, the lower side of the light string accommodation unit is connected to the rotating plate 9, at this time, the light string accommodation unit rotates along with the rotating plate 9 to retract the light string 2-3 thereinto for the convenience of folding and carriage of the solar powered lighting device.

Basic principles and main features of the present disclosure and advantages of the present disclosure have been shown and described above. The components mentioned in the present disclosure are common techniques in the prior art, and those who skilled in the art should understand that the present disclosure is not limited by the above-mentioned embodiments, and the above-mentioned embodiments and the description are merely illustrative of a principle of the present disclosure, and the present disclosure may also have various changes and improvements without departing from a spirit and scope of the present disclosure, and these changes and improvements shall all fall within a protection scope of the present disclosure. The protection scope of the present disclosure is defined by the appended claims and their equivalents.

What is claimed is:

1. A solar powered lighting device, comprising:
an upper housing;
a lighting structure; and
an outer housing;
wherein the lighting structure is disposed in the outer housing, and the upper housing is fixed to a top portion of the outer housing;
the lighting structure comprises a solar photovoltaic panel, a solar battery compartment, a light string, and a light string accommodation unit;
the light string is fixed on the light string accommodation unit, the solar battery compartment is disposed on a top portion of the light string accommodation unit, the solar battery compartment is connected to the solar photovoltaic panel, and the solar photovoltaic panel is disposed on a top portion of the upper housing;
the upper housing comprises a mounting frame, the solar photovoltaic panel is fixed in the mounting frame, a solar battery is disposed in the solar battery compartment, the solar battery is electrically connected to a first end of the light string, and a light string hook is disposed at a second end of the light string;
the light string accommodation unit is rotatably connected to the upper housing or the solar battery compartment through a bearing;
the light string accommodation unit comprises an upper fixing plate, a fixing column, and a lower fixing plate, the upper fixing plate and the lower fixing plate are connected through the fixing column, the upper fixing plate, the fixing column, and the lower fixing plate are integrated, a cross section of the light string accommodation unit is I-beam shaped, and one side of the light string is fixed on the fixing column;
a mounting hole is defined on a bottom portion of the outer housing, a rotating plate is mounted at the mounting hole through a peripheral groove thereof, and the light string accommodation unit is fixed on the rotating plate; and
a recess is defined on a first side of the rotating plate, an accommodation groove is defined on a second side of the rotating plate, an insertion hole penetrates through the accommodation groove, the lower fixing plate defines a threaded hole configured to operatively engage with a retraction rod.

2. The solar powered lighting device according to claim 1, wherein at least one fixing post is disposed on an inner side of the upper housing, at least one fixing groove is defined on an inner portion of the outer housing;
the at least one fixing post corresponds to the at least one fixing groove; and
the upper housing and the outer housing are fixed through engagement of the at least one fixing post and the at least one fixing groove.

3. The solar powered lighting device according to claim 1, wherein at least one indication light, a switch, a control chip, and a microwave human body thermal sensor are disposed on an upper surface of the upper housing, and the control chip is respectively connected to the at least one indication light, the switch, the solar battery compartment, and the microwave human body thermal sensor.

4. The solar powered lighting device according to claim 3, wherein the air outlet assembly comprises a first magnetic component, a second magnetic component magnetically engaging with the first magnetic component is disposed at the air outlet.

5. A method of using the solar powered lighting device according to claim 1, comprising:
S1: hanging the solar powered lighting device on an outdoor fixing support through a hanging rope, pulling the light string hook to draw out the light string, and fixing the light string to provide uniform lighting to surrounding areas;
S2: turning on a switch to activate the solar battery compartment to convert solar energy into electrical energy, storing the electrical energy in the solar battery or energizing the light string by the solar battery to emit light for ambient lighting; and
S3: turning off the switch after use, rotating the retraction rod through a rotating shaft to disengage the retraction rod from the light string accommodation unit, detaching the retraction rod from the rotating shaft, inserting the retraction rod into the lower fixing plate through the insertion hole of the accommodation groove, rotating the retraction rod, fixing the retraction rod to the lower fixing plate, rotatably connecting an upper side of the light string accommodation unit to the upper housing, providing no connection between a lower side of the light string accommodation unit and the outer housing, rotating the light string accommodation unit along with the retraction rod to retract the light string into the light string accommodation unit for folding and carriage of the solar powered lighting device.
